(19) United States
(12) Patent Application Publication
(10) Pub. No.: US 2008/0133271 A1
(43) Pub. Date: Jun. 5, 2008

(54) Job dispatcher for medical intelligent server architecture

(75) Inventor: JaeJung Chang, Milpitas, CA (US)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/606,075

(22) Filed: Nov. 30, 2006

(51) Int. Cl. G06Q 50/00; G06F 9/46

(52) U.S. Cl. 705/3; 718/100

(57) ABSTRACT

A dispatcher in a system for providing computer aided detection services for patient cases is disclosed. The dispatcher dynamically accepts cases from external devices and manages distribution of the cases among one or more image processing servers. The dispatcher includes a job dispatcher process, which creates a child dispatcher process for each connection to an external device in one-to-one correspondence, and a registration service for managing operating status information for one or more image processing servers. Each child process is assigned responsibility for managing an association for a connection. Establishing an association involves accepting or rejecting a case and dispatching the case to an image processing server. Each child dispatcher process is allocated its own dedicated cache memory for temporary storage of incoming image files. Thus, a dispatcher is disclosed that is capable of managing a large number of cases with high throughput in performing computer aided detection that is limited only by the amount of main memory in the computer running the dispatcher.

### CROSS-REFERENCES TO RELATED APPLICATIONS

A related application entitled “Medical Intelligent Server Architecture,” is being filed concurrently herewith, to JaeJung Chang, Attorney Docket 3352-0144PUS1, and is herein incorporated by reference.

### BACKGROUND OF THE INVENTION

1. Field of the Invention

This invention relates to the art of medical computer aided detection, and more specifically, to computer aided detection based on a case consisting of a set of medical images. The present invention is a job dispatcher for a medical intelligent server for managing the computer aided detection.

2. Description of Related Art

Hospital information systems, medical laboratory systems, as well as computer networks for various clinics and medical practices are obtaining and storing an increasing amount of medical data and medical images. In the area of computer aided detection (CAD), sophisticated algorithms are being developed that accurately detect diseases such as cancer and provide valuable detection information based on the medical data and medical images. Over time, Hospitals and other medical practices have replaced conventional clinical charts with electronic clinical charts, and databases of clinical histories and medical prescription histories have been installed. Radiology information systems have been implemented to provide information that can be used for diagnosis. More recently, Picture Archiving and Communication Systems (PACS) have become a replacement for hard-copy based means for managing medical images, such as film archives.

PACS are computer systems dedicated to the storage, retrieval, distribution and presentation of medical images. Full PACS handle more than one image type and associated modalities, including ultrasonography, magnetic resonance imaging, position emission tomography, computed tomography, endoscopy, mammography and radiography (plain X-rays).

A typical PACS network may consist of a central server that stores a database containing images. The central server may be connected to client workstations in a LAN or WAN, as well as over the Internet. Client workstations can include local peripherals for scanning image films into the system (e.g., film digitizer), printing image films from the system and interactive display of digital images. PACS workstations offer means of manipulating the images obtained from the local peripherals (crop, rotate, zoom, brightness, contrast, etc.).

Many types of imaging equipment are capable of feeding patient images directly to the PACS in digital form. Many Hospitals and other medical practices are currently using a standard for handling the many types of medical data, known as Digital Imaging and Communications in Medicine (DICOM), a NEMA standard. DICOM includes a file format definition and a network communications protocol. DICOM was developed to enable integration of scanners, servers, workstations, printers and network hardware from multiple vendors.

The DICOM standards are seen as an improvement over a popular Analyze format. The Analyze format stores the image data in one file (*.img) and the header data in another file (*.hdr). DICOM, on the other hand, requires a single DICOM file that contains both a header (which stores information about the patient and image, such as patient name, type of scan, image dimensions, etc.), and all of the image data (which can contain information for three dimensional images). In addition, the DICOM standard allows for compression (encapsulation) of the image to reduce the amount of image data in the file (any of several popular compression standards are supported, including JPEG, JPEG Lossless, JPEG 2000, LZW and Run-length encoding). Furthermore, though a single DICOM object can only contain one image, the image may have multiple frames, allowing storage of cine or other multi-frame data.

The header provided by the DICOM file format can contain standardized fields and free-form fields. The size of the header varies depending on how much header information is stored. DICOM files contain required elements, which are dependent on the image type (i.e., modality). For example, the image modality MR should have elements to describe the MRI echo time. Absence of this information from this modality would be a violation of the DICOM standard.

Among information contained in a DICOM header, is a Transfer Syntax Unique Identification (UID). The Transfer Syntax UID defines the structure of the image data, identifying whether the image data has been compressed, and identifying the byte order of the raw data.

A PACS system is capable of managing a large number of medical images for many patients. The DICOM standard defines a protocol and data format for transmitting medical images from many types of medical imaging equipment. There is a need for a system to apply the vast amount of medical image data to CAD algorithms to provide diagnosis for an increasing number of patients, illnesses, in an environment where new and modified CAD algorithms are being developed and new image modalities are being added. Over a long term, the system should be capable of adapting to new or modified modalities and related CAD algorithms, as well as be capable of scaling up to an increasing number of patients and illnesses. It is preferable that such a system be capable of integrating with existing systems.

### BRIEF SUMMARY OF THE INVENTION

An aspect of the present invention is an architecture capable of scaling up for increasing number of patients and diseases, and capable of facilitating modifications and additions of new CAD algorithms for respective modalities. The present invention provides detection services for determining a diagnosis upon being provided a set of medical images for a patient study, also referred to as a case. The present invention is capable of being integrated into existing hospital systems. The present invention can adapt to changes in demand for detection services.

A particular aspect of the present invention is a job dispatcher that receives DICOM images for a case from a DICOM device and dispatches the images to the appropriate image processing server. The parent job dispatcher creates child job dispatchers and delegates receiving images related to cases and dispatching the images. When there is more than one Image Processing Server, a child job dispatcher selects an image processing server having the lightest load to perform the desired detection service.

Aspects of the job dispatcher include a dispatcher service running on a computer for a medical intelligent server, the dispatcher dynamically accepts patient cases from one or more medical imaging devices and manages distribution of the cases among one or more image processing servers, the dispatcher service having

a job dispatcher process, which upon detecting a connection request from a medical imaging device, creates a child dispatcher process as a separate process to manage communication with the medical imaging device and with an image processing server; and

a registration service that manages operation status information and existence information of detection services for the one or more image processing servers, wherein the child dispatcher process accepts a request to perform detection services, and based on the existence information of the detection services and the status information maintained in the registration service, selects an image processing server to perform the requested services for a patient case and dispatches the patient case to the selected image processing server.

Provided a dispatcher service in which a job dispatcher process creates a child dispatcher process as a separate process to manage communication with the medical imaging device, the number of concurrent communication connections to medical imaging devices is limited only by the amount of memory on the computer running the job dispatcher. Because the job dispatcher of the present invention is running on a dedicated machine, the present invention can handle a large number of requests for services based on patient cases.

Provided a dispatcher service in which a registration service manages operation status information for one or more image processing servers so that image processing servers are selected based on the status information enables dynamic load balancing. Thus, by creating child processes to handle communications with a varying number of requesting medical imaging devices on the input side, and dispatching patient cases to image processing servers based on status maintained in a registration service, the present invention is adaptable to changes in demand for services.

A patient case of the dispatcher service includes one or more medical image files, and during creation of the child dispatcher process the job dispatcher process assigns the socket of the requested connection to the child dispatcher process for communications with a requesting medical imaging device, and allocates a dedicated local memory to the child dispatcher process for temporarily storing image files of the one or more medical image files.

Provided allocation of a dedicated local memory to a child dispatcher process, the present invention can achieve greater throughput with reduced access to a hard drive. Because each child dispatcher process is a separate process, a greater amount of memory can be allocated than if dispatching were implemented as part of the job dispatcher process.

In the dispatcher service, upon being assigned a socket of the requested connection, the child dispatcher process performs negotiation to accept or reject an association with the medical imaging device of the connection, and if the association is granted the child dispatcher process receives the image files.

Provided that a child dispatcher process is delegated the responsibility of negotiation of association with a medical imaging device, enables the job dispatcher process to quickly proceed with managing other communication connections. Thus, the present invention is capable of handling a large number of communication connection requests from medical imaging devices.

The one of more medical image files of the dispatcher service are transmitted from the medical imaging device directly to the memory of the child dispatcher process independently from the job dispatcher process.

Provided a direct connection between a medical imaging device and the memory of a child dispatcher process enables concurrent receiving of medical image files based on the number of child dispatcher processes.

The status information obtained from the registration service includes status on the number of cases in a queue of an image processing server and on the number of cases currently being processed by the same image processing server, wherein the child dispatcher process selects an image processing server based on the image processing server that has the lowest number of cases in its respective queue and being processed.

Provided a registration service that maintains status on the number of cases in a queue of an image processing server and currently being processed, the dispatcher service of the present invention is capable of dispatching patient cases in an informed manner that balances the workload among image processing servers.

The local memory of the child dispatcher process is a dedicated cache memory, and if the number of image files exceeds a predetermined threshold, the child dispatching process stores a number of image files up to the threshold quantity in the cache memory, and stores image files exceeding the threshold quantity in a hard drive associated with the dispatcher.

Provided a local memory of the child dispatcher process is a dedicated cache memory, the present invention can efficiently dispatch image files to image processing servers without a substantial number of disk accesses. It is anticipated that in most patient cases, few disk accesses to obtain image files would be necessary.

### BRIEF DESCRIPTION OF THE SEVERAL VIEWS OF THE DRAWINGS

In the drawings:

FIG. 1 shows a block diagram of the Medical Image Intelligence Server (MIIS).

FIG. 2 shows the general architecture of the Job Dispatcher Module.

FIG. 3 shows information flow for the Job Dispatcher Module within the MIIS.

FIG. 4 shows a workflow diagram for the Job Dispatcher Module.

FIG. 5 shows a flow diagram for the study handler.

FIG. 6 shows an example user interface of a Console for the Job Dispatcher Service.

### DETAILED DESCRIPTION OF THE INVENTION

The present invention will be described in further detail with reference to the accompanying drawings. An example embodiment of the present invention has been implemented using Microsoft Windows family of operating systems and related products. Thus, the following preferred embodiment of the present invention will be described using Microsoft Windows terminology. Platforms running one of several Unix operating system derivatives (e.g., Sun OS, Mac OSX, Linux), other multitasking operating systems, or a combination of operating systems, can be provided as alternative embodiments of the present invention.

### Definition of Terms and Acronyms

The following definitions are provided for terms used throughout the description.

Association (DICOM protocol): a communication connection established between two DICOM applications by which DICOM information is exchanged. An association is preceded by initiation of a connection. An association is established by a process referred to as association negotiation.

Graphical User Interface (GUI): A program interface that takes advantage of the computer's graphics capabilities to make the program easier to use. A user interface to a computer program that is considered an alternative to a GUI is a command-driven interface. Current GUI's have a pointer and associated pointing device that enables the user to select graphical objects on the display screen. GUI's can display functional components such as icons, menus, scroll bars that enable functions such as activating a command, or manipulating the display.

Message: a unit of information passed among running programs, devices, and within the operating environment. The unit of information can contain one or more blocks of text, control characters, a header, and error-checking or synchronization information.

Module: A collection of related application programs and service applications.

Server: A computer or device on a network that manages resources and delivers service applications that can be used by other computers in the network.

Study (DICOM, also case): the DICOM term for a set of images of an image modality produced during a visit to a hospital, clinic, or other medical practice.

Task (also Process): A combination of a program being executed and bookkeeping information used by the operating system. When a program is executed by the computer, the operating system creates a new task for it. The task constitutes a wrapper for the program that identifies the program with a task number and attaches other bookkeeping information to it.

Transfer Syntax (from DICOM PS.3.5 2004): A set of encoding rules that allow Application Entities to unambiguously negotiate the encoding techniques (e.g., Data Element structure, byte ordering, compression) they are able to support, thereby allowing these Application Entities to communicate.

Windows Service (Microsoft): a highly specialized type of application designed to run for extended periods in its own Windows session. A Windows service typically runs as a background process, usually with no user interface, either locally or in a network. Most server-based applications, for example, are services. Windows services can be started from the Microsoft Management Console.

Modalities: CT, MR, CR, Ultrasound, and Nuclear Medicine systems, or imaging devices and equipment that send C-STORE requests (requests to store digital images in another system). Modalities have associated image modalities.

### Example Modalities:

AS=Angioscopy
BI=Biomagnetic Imaging
CD=Color Flow Doppler
CP=Culposcopy
CR=Computed Radiography
CS=Cystoscopy
CT=Computed Tomography
DD=Duplex Doppler
DG=Diaphanography
DM=Digital Microscopy
DS=Digital Subtraction Angiography
DX=Digital Radiography
EC=Echocardiography
ES=Endoscopy
FA=Fluorescein Angiography
FS=Fundoscopy
HC=Hard Copy
LP=Laparoscopy
LS=Laser Surface Scan
MA=Magnetic Resonance Angiography
MR=Magnetic Resonance
MS=Magnetic Resonance Spectroscopy
NM=Nuclear Medicine
PT=Positron Emission-Tomography (PET)
RF=Radio Fluoroscopy
RG=Radiographic Imaging (conventional film screen)
RTDOSE=Radiotherapy Dose
RTIMAGE=Radiotherapy Image
RTPLAN=Radiotherapy Plan
RTSTRUCT=Radiotherapy Structure Set
ST=Single-photon Emission Computed Tomography
TG=Thermography
US=Ultrasound
XA=X-Ray Angiography
XC=eXternal Camera
ECG=Electrocardiograms

CAD (Computer Aided Detection): algorithms, for example pattern recognition algorithms, designed to detect regions in medical images that may be indications of diseases or illnesses.

DICOM: (Digital Imaging and Communications in Medicine). Is a comprehensive set of standards for handling, storing, printing and transmitting information in medical imaging. It includes file format definition and a network communications protocol. The protocol uses TCP/IP to communicate between systems. DICOM files can be exchanged between two entities that have the capability to receive the information—image and patient data—in DICOM format. See dicom.nema.org.

PACS: (Picture Archive and Communication System). Commercially available PACS provide an architecture that contains input modalities, a DICOM server, a PACS server, an Archive server, a Web server, a RIS (Radiology Information Server), and Radiology clients.

### SOAP: (Simple Object Access Protocol).

### Medical Image Intelligent Server (MIIS)

The job dispatcher of the present invention is part of a Medical Image Intelligent Server (MIIS). The Medical Image Intelligent Server (MIIS) can be considered as a dedicated Computer Aided Detection (CAD) server. The MIIS provides services for helping doctors and radiologists use advanced algorithms for performing medical diagnosis. The MIIS provides an architecture that can scale up to handle a growing number of patients and adapted to new modalities and body parts. Growth is accommodated by a scaleable architecture that is easy to upgrade.

The Medical Image Intelligent Server provides advanced CAD by sophisticated algorithms that accurately detect diseases such as cancer and subsequently provides valuable detection information. The MIIS is designed to fit into existing hospital systems and workflows, as well as new hospital systems. The MIIS is based on a flexible architecture and uses the DICOM standard communication protocol. Detection services are performed without significant delay. A built-in Web server enables 24/7 system access and report generation.

CAD has proven to be a successful tool for assisting doctors. For example, CAD has been useful in assisting doctors with patients having late stage illnesses. The MIIS facilitates greater capacity and growth in number and types of CAD services.

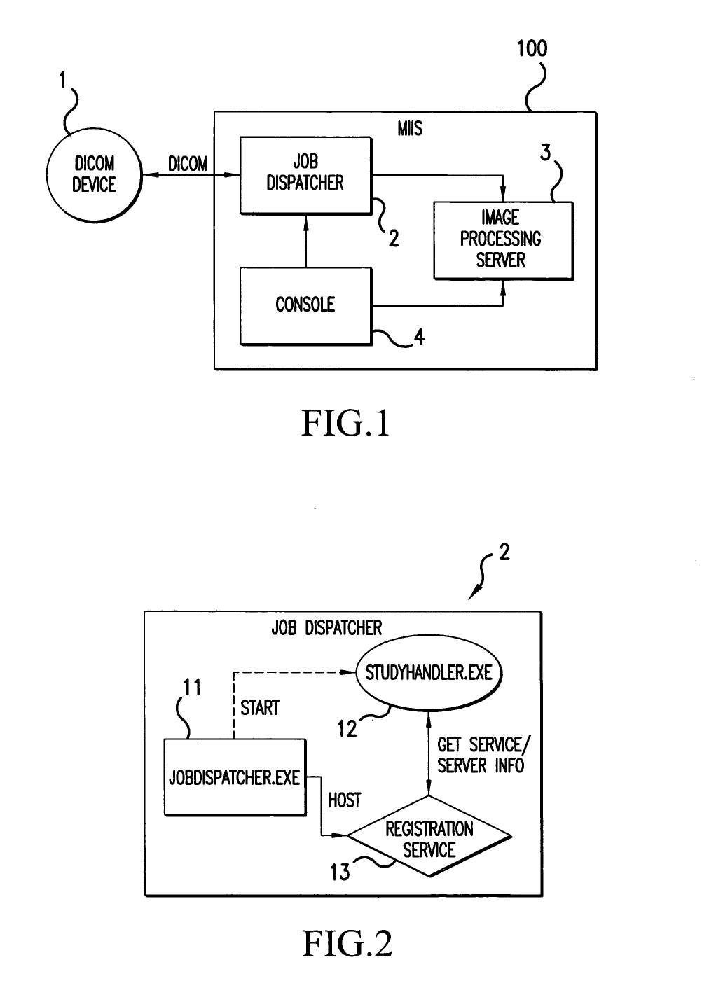

A conceptual view of the Medical Image Intelligent Server is shown in FIG. 1. As shown in FIG. 1, the MIIS receives images from DICOM compatible devices as inputs and performs CAD image processing. The MIIS 100 contains a Job Dispatcher Module 2, at least one Image Processing Server 3, and a console 4. A Job Dispatcher Module 2 of the MIIS can receive images from DICOM devices 1 (one shown for simplicity) through a DICOM C-Store service, and transmit the images to Image Processing Servers 3 (one shown for simplicity). The Console 4 provides a graphical user interface to the MIIS.

The throughput requirement for large-scale hospital systems goes far beyond the capabilities that a single server can provide. The MIIS provides the capability to add Image Processing Servers and coordinate their workload in order to reach suitable performance. The Job Dispatcher Module 2 facilitates the scalability of the MIIS in order to meet demands for greater throughput.

### Job Dispatcher Module

The Job Dispatcher of the present invention facilitates variance in required capacity. The Job Dispatcher is capable of concurrently managing a varying number of requests for detection services on demand at the input side and dispatch jobs in a manner that balances workload among a varying number of processing servers on the output side, in a system that can accommodate a growing number of detection services.

FIG. 2 shows a schematic view of the Job Dispatcher Module 2 of the present invention. The Job Dispatcher Module 2 includes a Job Dispatcher provided as a service application (Job Dispatcher Service 11) and a Registration Service 13. The Job Dispatcher Service 11 starts one or more child processes (referred to as a StudyHandler 12) to handle each incoming DICOM association. A StudyHandler 12 performs association negotiation, stores received DICOM images and manages dispatching of received images to a selected Image Processing Server 3 based on information maintained by the Registration Service 13.

Each Image Processing Server 3 in the MIIS 100 can register with the Registration Service 13 by providing which detection services, and the location of the detection services, the Image Processing Server 3 can process. Image Processing Servers 3 also inform the Registration Service 13 of their current workload status. The StudyHandler 12 process dispatches received DICOM images based on information on workload status and Information Processing Servers that can process a requested detection service.

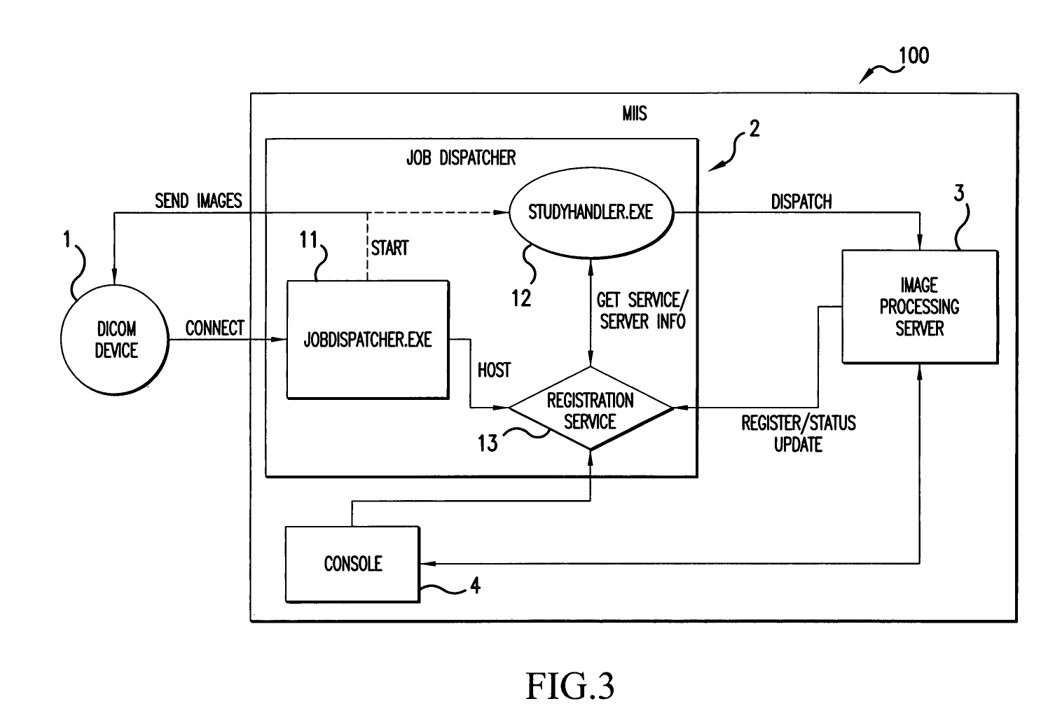

FIG. 3 shows the role of the Job Dispatcher Module 2 in the MIIS 100. An Image Processing Server 3 will inform the Registration Service 13 of its operating status and update its status as necessary (“Register/Status Update”). The principal Job Dispatcher Service 11 listens for incoming connection requests from DICOM devices 1, and upon accepting a connection (DICOM protocol), starts a StudyHandler 12 process “Start”) and hands over management of the association. The StudyHandler 12 conducts negotiation of the association and either accepts or rejects the association. Upon accepting an association, the StudyHandler 12 receives and stores DICOM images (“Send Images”). Depending on the number and workload of Image Processing Servers, the StudyHandler 12 will select an Image Processing Server and dispatch images for a case to the selected Image Processing Server to perform detection services (“Dispatch”).

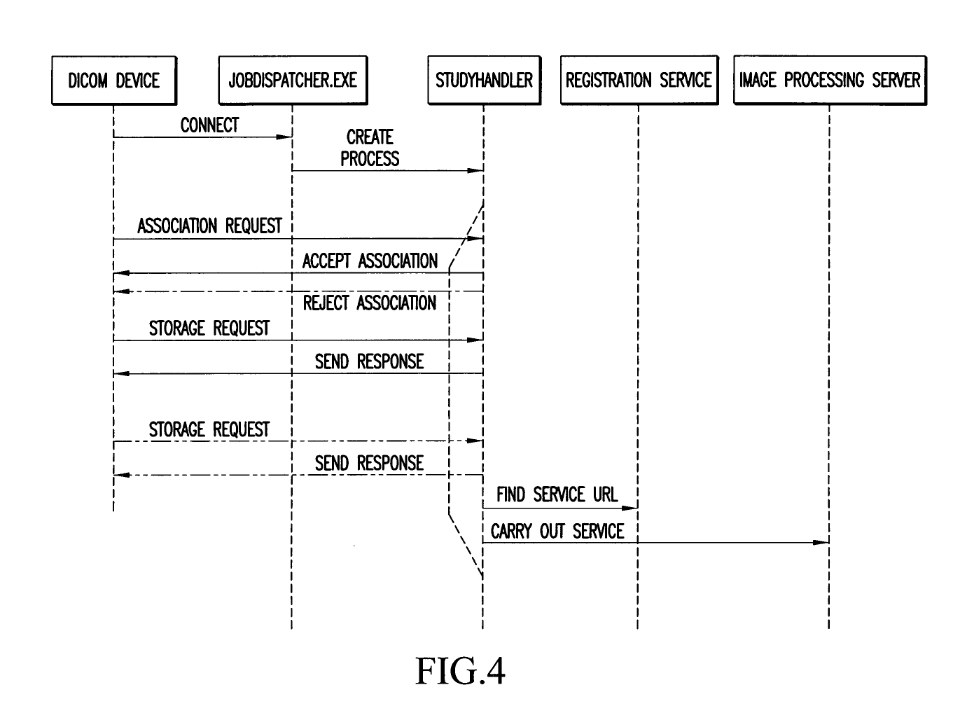

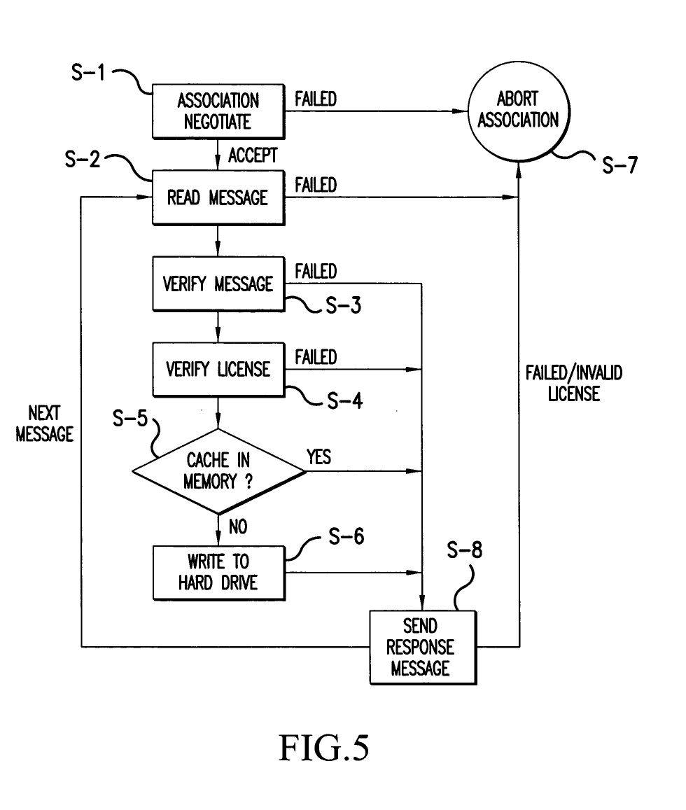

FIG. 4 shows an example workflow of the Job Dispatcher Module of FIG. 3. A DICOM device communicates with the Job Dispatcher Service 11 using the DICOM protocol in order to request a connection for storage of DICOM images (“Connect”). The Job Dispatcher Service 11 receives a request, builds the connection and informs the DICOM device of the connection. An acknowledgement is received from the DICOM device and the Job Dispatcher Service sends a final response to confirm the connection. The Job Dispatcher Service 11 then starts a StudyHandler 12 process in order to delegate management of an association. In an example embodiment, the Job Dispatcher Service 11 invokes a method such as “CreateProcess” with the parameter “Socket ID” set to the communications port of the association. Subsequently, once a StudyHandler 12 is started, the StudyHandler 12 takes over control of the association and conducts negotiation to accept or reject the association (“Association Request”). Upon acceptance of proposed detection services an association is established (“Accept Association”). The DICOM device submits images to be stored (“Storage Request”), and the StudyHandler 12 responds with a message that the storage has been completed (“Send Response”). The StudyHandler 12 sends a message to the Registration Service requesting information of an Image Processing Server that can provide necessary detection services (“Find Service URL”). Upon selecting an Image Processing Server, the StudyHandler 12 performs dispatching to the Image Processing Server 3 for carrying out the detection services (“CarryOutService”).

As new connections are established with DICOM devices 1, new StudyHandler 12 processes can be started and executed concurrently in the MIIS. The Job Dispatcher Service 11 is responsible for monitoring and controlling the number of StudyHandler 12 child processes that are started.

### StudyHandler

Each StudyHandler is provided with its own resources, including a dedicated cache memory. By creating a child process for each new association, a large number of DICOM images can be handled by the Job Dispatcher Module. Because each child process has its own dedicated resources, including a cache memory, the large number of DICOM images can be distributed to Image Processing Servers at a high throughput rate and without delays from hard drive accesses. The number of images that can be handled concurrently is limited primarily by the size of main memory in the machine running the Job Dispatching Module. The number of associations that can be handled concurrently is limited by network bandwidth, processor speed, and the amount of available physical memory.

The StudyHandler 12 may reject an association (“Reject Association”) for the following reasons: 1) no Image Processing Server is currently registered, 2) licensing validation has failed, either because no licensing information is available, the license is invalid, or the license has expired, 3) the MIIS is busy as the number of connections has reached its allowed maximum, or 4) there is an internal server error. The number of concurrent associations that the Job Dispatcher Service can handle depends on the capability of the machine that the MIIS is running.

The StudyHandler 12 is responsible for performing this association negotiation, as well as for receiving messages, and dispatching studies (as defined above, a study is the DICOM term for a case, where a case is the set of images obtained during a patient office visit). In particular, the StudyHandler examines received DICOM objects to verify that they have required attribute values for Image Processing Servers to process. FIG. 5 shows an example workflow for association negotiation and receiving messages. In step S-1, the StudyHandler accepts the association if requested services (i.e., detection services related to modalities) and presentation context are acceptable. Each StudyHandler handles association negotiation relying on information provided according to a standard presentation context. Otherwise, an association is aborted, step S-7, and the StudyHandler process stops. Table 1 shows an example presentation context.

Presentation Context Table
Presentation Context Table

| Abstract Syntax | | Transfer Syntax | | | Extended |
|---|---|---|---|---|---|
| Name | UID | Name | UID | Role | Negotiation |
| Computed | 1.2.840.10008.5.1.4.1.1.1 | Implicit VR, Little | 1.2.840.10008.1.2 | SCP | None |
| Radiography | | Endian | | | |
| Image Storage | | Explicit VR, Little | 1.2.840.10008.1.2.1 | SCP | None |
| | | Endian | | | |
| | | Explicit VR, Big Endian | 1.2.840.10008.1.2.2 | SCP | None |
| | | JPEG LOSSLESS | 1.2.840.10008.1.2.4.70 | SCP | None |
| | | HIER 14 | | | |
| Digital | 1.2.840.10008.5.1.4.1.1.1.2 | Implicit VR, Little | 1.2.840.10008.1.2 | SCP | None |
| Mammography | | Endian | | | |
| Image Storage - | | Explicit VR, Little | 1.2.840.10008.1.2.1 | SCP | None |
| For | | Endian | | | |
| Presentation | | Explicit VR, Big Endian | 1.2.840.10008.1.2.2 | SCP | None |
| | | JPEG LOSSLESS | 1.2.840.10008.1.2.4.70 | SCP | None |
| | | HIER 14 | | | |
| Digital | 1.2.840.10008.5.1.4.1.1.1.2.1 | Implicit VR, Little | 1.2.840.10008.1.2 | SCP | None |
| Mammography | | Endian | | | |
| Image Storage - | | Explicit VR, Little | 1.2.840.10008.1.2.1 | SCP | None |
| For | | Endian | | | |
| Processing | | Explicit VR, Big Endian | 1.2.840.10008.1.2.2 | SCP | None |
| | | JPEG LOSSLESS | 1.2.840.10008.1.2.4.70 | SCP | None |
| | | HIER 14 | | | |

If an association is accepted, in steps S-2, S-3 and S-4 the StudyHandler receives and verifies messages. In order to speed up the receiving process, in step S-5 the StudyHandler first tries to cache received images in a memory, and avoid hard drive accessing. Upon exceeding a threshold of the number of images that can be cached, in step S-6 images are written to the hard drive. In step S-8, the StudyHandler sends a response message.

A Registration Service 13 holds and manages information of Image Processing Servers. The information includes detection services that the Image Processing Servers provide, the process and protocol necessary to request each service by a Image Processing Server, and location of the Image Processing Servers (e.g., local machine, or IP address).

An Image Processing Server 3 needs to be registered with the Registration Service 13 before it can be a member of a service group. The StudyHandler 12 of the Job Dispatcher Module will retrieve registration information so that it can select an Image Processing Server 3 for performing a detection service. Archived information needs to be updated when the system configuration changes: for example, add/remove an Image Processing Server, or add/upgrade a detection service.

If more than one Image Processing Server 3 can process a requested service, the StudyHandler 12 performs load balancing and invokes functions in the Registration Service 13 to obtain the service URL for the Image Processing Server having the lightest load (assuming multiple Image Processing Servers are registered), and dispatch a received study to the selected Image Processing Server 3. If more than one case is received, StudyHandler 12 will repeat the process and send one case at a time. If images are received in a priority IP list, a case will be set to high priority when dispatching.

Each StudyHandler 12 uses DICOM as its communications protocol for communication with external devices. For internal communications within the MIIS, each StudyHandler 12 uses SOAP to communicate with components internal to the MIIS.

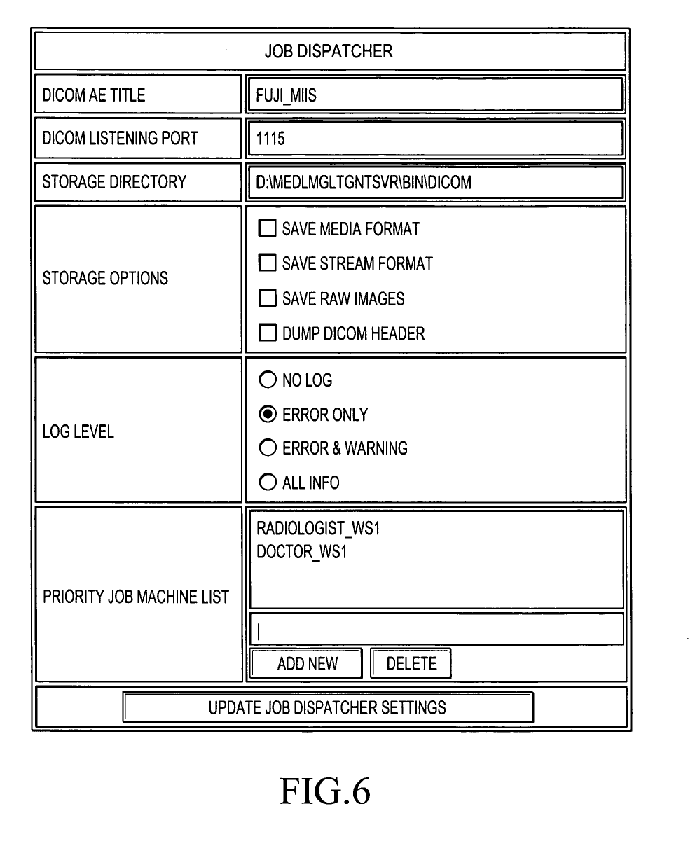

In an example embodiment, the MIIS Console 4 displays a Server Configuration page. As shown in FIG. 6, an Administrator can change Job Dispatcher settings by way of the Server Configuration page. For example, an Administrator can designate the title of a receiving stream from a DICOM compliant device, the port which the Job Dispatcher is listening, and a directory on the hard drive where received objects are saved. An Administrator can designate storage options and level of information to be recorded to the log. An Administrator can set priority for workstations or other sources that submit jobs to the MIIS.

### Registration Service

The Registration Service 13 of the Job Dispatcher Module operates in a listening mode enabling an Image Processing Server 3 to register services provided by the Image Processing Server, or to report the status of the Image Processing Server. For example, an Image Processing Server 3 can report the number of services being executed and the number of diagnosis jobs currently in the queue and waiting to be executed. The Registration Service 13 maintains status information of each Image Processing Server that has been registered.

### Registration Service Functions

In order to maintain the status information, the Registration Service provides management functions for the MIIS, including the following.

### Image Processing Server:

Functions are available that can be invoked by an Image Processing Server.

REGISTER (UN-REGISTER): An Image Processing Server can invoke the function Register or Un-register Server to allow Image Processing Servers to subscribe/un-subscribe to the image dispatching service of StudyHandler's. Information provided with the Register function includes a list of supported services each having a service name and service URL.

UPDATE STATUS: An Image Processing Server can invoke the function Update Status, which enables the Image Processing Server to update status information including the number of cases being processed and the number of cases waiting in a queue.

EVENT: An Image Processing Server can invoke a function to report an event.

### Study Handler:

The Registration Service provides management functions for a StudyHandler.

FIND SERVER: A function is available for a StudyHandler to search Image Processing Servers by service name. In response to the function, a list of Image Processing Servers is provided sorted by current load with lightest on top. The load of a server is defined as the average number of cases waiting per virtual processor:

Load=(Q+E)/V

where, Q is the number of cases waiting on queue, E is the number of cases under processing, and V is the number of equipped virtual processors.

GET SERVICE URL: A function is available for obtaining a service URL given a server name and a service name.

GET STATUS: A function is available for obtaining the status of an Image Processing Server. The function returns the number of cases processing and the number of cases waiting on queue.

GET SERVICES: A function is available to obtain a list of available services of registered Image Processing Servers.

### Console:

The Console 4 provides a graphical user interface that enables retrieval of information from the Registration Service.

The Console provides functions including GET EVENT LOG—to retrieve a list of events that occurred over a period of time; GET JOB DISPATCHER CONFIGURATION—to retrieve and send the current JOB DISPATCHER configuration settings; CHANGE JOB DISPATCHER CONFIGURATION—to invoke the Job Dispatcher and update internal parameter values in the memory; GET NUMBER OF REGISTERED SERVERS—to obtain the number of registered Image Processing Servers; GET LICENSE INFO—to obtain current license information.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A dispatcher service running on a computer for a medical intelligent server, the dispatcher dynamically accepting patient cases from one or more medical imaging devices and managing distribution of the cases among one or more image processing servers, the dispatcher service comprising:
a job dispatcher process, which upon detecting a connection request from a medical imaging device, creates a child dispatcher process as a separate process to manage communication with the medical imaging device and with an image processing server; and
a registration service that manages operation status information and existence information of detection services for the one or more image processing servers, wherein
said child dispatcher process accepts a request to perform detection services, and based on the existence of the detection services and the status information maintained in the registration service, selects an image processing server to perform the requested services for a patient case and dispatches the patient case to the selected image processing server.

2. The dispatcher service of claim 1, wherein a patient case comprises one or more medical image files, and during creation of the child dispatcher process the job dispatcher process assigns a socket of the requested connection to the child dispatcher process for communications with a requesting medical imaging device, and allocates a dedicated local memory to the child dispatcher process for temporarily storing image files of said one or more medical image files.

3. The dispatcher service of claim 2, wherein upon being assigned a communication connection, said child dispatcher process performs negotiation to accept or reject an association with the medical imaging device of the connection, and if the association is granted the child dispatcher process receives the image files.

4. The dispatcher service of claim 2, wherein the one of more medical image files are transmitted from the medical imaging device directly to the memory of the child dispatcher process independently from the job dispatcher process.

5. The dispatcher service of claim 1, wherein the status information obtained from the registration service includes status on the number of cases in a queue of an image processing server and on the number of cases currently being processed by the same image processing server, wherein the child dispatcher process selects an image processing server based on the image processing server that has the lowest number of cases in its respective queue and being processed.

6. The dispatcher service of claim 1, wherein the local memory of the child dispatcher process is a dedicated cache memory, and if the number of image files exceeds a predetermined threshold, the child dispatching process stores a number of image files up to the threshold quantity in the cache memory, and stores image files exceeding the threshold quantity in a hard drive associated with the dispatcher.

7. A dispatcher executing in a processing system for dynamically accepting requests for detection services and managing distribution of the requests among one or more image processing servers that are capable of performing computer aided detection for a plurality of image types, said dispatcher comprising:
a job dispatcher process for detecting requests for computer aided detection services, for acknowledging a connection upon receiving a request, and for starting a child job dispatcher process upon acknowledging the request;
a registration service for receiving registration information from one or more image processing servers for one or more computer aided detection service applications, for receiving status information including the number of computer aided detection service applications assigned for execution on an image processing server, and for providing the status information to a child job dispatcher process,
wherein upon creation of the child job dispatcher process, said child job dispatcher process receives one or more image files, obtains status information from the registration service, and dispatches said image files to an image processing server based on a capability of performing a computer aided detection service for the image type contained in the image files and based on status information obtained from the registration service.

8. A dispatcher executing in a server computer, the server computer receiving a plurality of patient cases each having one or more medical image files, wherein each of the image files include both header information and image data in a single file, and performing respective computer aided detection services based on the image type of the image data as indicated in the header information, said dispatcher comprising:
a job dispatcher process, which upon detecting a request for connection, creates a child dispatcher process, delegates responsibility for managing an association for the connection to the child dispatcher process, and allocates local dedicated storage for the child dispatcher process, wherein said child dispatching process receives one or more patient cases over the connection; and
a registration service for managing operating status information and types of detection services for at least one image processing server;
wherein each said child dispatcher process dispatches image files for respective patient cases to the at least one image processing server based on the operating status information and types of detection services, such that each child dispatcher process manages image files for a respective patient cases.

9. The dispatcher of claim 8, wherein each child dispatcher process is responsible for accepting or rejecting a respective association.

10. The dispatcher of claim 8, wherein each child dispatcher process selects one of a plurality of image processing servers based on status information obtained from the registration service that indicates current processing load and available detection services for each image processing server, wherein the selected image processing server is the one with the lightest processing load.

11. A method for dispatching image files for a plurality of patient cases to one or more image processing servers for performing computer aided detection based on the image files, the method is performed by a server computer comprising a job dispatcher service and a registration service, the job dispatcher service dispatching image files based on information of operation status and types of detection services obtained from the registration service, the method comprising:
detecting a request to form a connection with an external device;
upon forming a connection with the external device, creating a child dispatcher process from the job dispatcher service;
assigning a socket of the requested connection to the child dispatcher process, and establishing an association for the connection;
receiving image files, each file having header information and image data, and storing the image files in a dedicated memory of the child dispatcher process;
dispatching the image files to an image processing server to perform detection services based on processing load;
transmitting results of the detection services to a display device for displaying.

12. The method for dispatching image files of claim 11, further comprising updating the operation status information of workload for an image processing server and dispatching the image files to an information processing server based on the updated status information of workload.

13. A method for dispatching image files for a plurality of patient cases to one or more image processing servers for performing computer aided detection based on the image files, the method is performed by a server computer having a job dispatcher service and a registration service, the job dispatcher service dispatching image files based on information of operation status and types of detection services obtained from the registration service, the method comprising:
detecting a plurality of requests to form connections with external devices;
creating a plurality of child dispatcher processes from the job dispatcher service, one child dispatcher process for each of the connections;
assigning a socket for each requested connection to a respective child dispatcher process, and establishing an association for the connection;
receiving image files over the respective connection and storing the image files in a dedicated memory of the corresponding child dispatcher process;
a responsible child dispatcher process selecting an image processing server to process image files for one or more said patient cases based on work load;
each respective child dispatcher process dispatching the image files to the corresponding selected image processing server to perform detection services; and
transmitting results of the detection services to a display device for display.
